(19) United States
(12) Patent Application Publication
(10) Pub. No.: US 2004/0141675 A1
(43) Pub. Date: Jul. 22, 2004

(54) Truck hub bearing unit with rotatable inner ring

(76) Inventors: Hendrikus Jan Kapaan, DM Nieuwegein (NL); Rico Dittmar, Schmalkalden (DE); Jesko-Henning Tanke, Schweinfurt (DE); Matts Arne Kurt Karlsson, Gothenburg (SE); Paul Bernard Meaney, Utrecht (NL)

Correspondence Address: Oliff & Berridge, PO Box 19928, Alexandria, VA, 22320, US

(21) Appl. No.: 10/485,521

(22) PCT Filed: Aug. 2, 2002
(86) PCT No.: PCT/NL02/00524

(30) Foreign Application Priority Data
Aug. 3, 2001 (NL) 1018698

(51) Int. Cl. F16C 13/00; F16C 35/00

(52) U.S. Cl. 384/589

(57) ABSTRACT

A truck hub bearing unit comprises two rolling element bearings, (3,4) which comprise an inner ring (9) means and an outer ring (5) means provided with raceways which are in rolling contact with two series of rolling elements, a fixed member or connection to the wheel suspension of the truck and a rotatable member or supporting a wheel, said rotatable member being supported with respect to the fixed member by means of said rolling bearings. The outer ring means is connected to the fixed member and the inner ring (9) means is connected to the rotatable member.

The invention is related to a t truck or trailer hub bearing unit, comprising two rolling element bearings, which comprise an inner ring means and an outer ring means provided with raceways which are in rolling contact with two series of rolling elements, a fixed member for connection to the wheel suspension of the truck and a rotatable member for supporting a wheel, said rotating member being supported with respect to the fixed member by means of said taper roller bearings, the outer ring means being connected to the fixed member and the inner ring means being connected to the rotatable member.

A truck hub bearing unit of this type is disclosed in DE-A-19700313. Said prior art truck hub bearing unit is suspended in a steerable fashion, and is connected to a drive shaft.

The object of the invention is to provide a truck hub bearing unit which is in particular fit for the steerable, non-driven wheels of a vehicle. To that end the fixed element is provided with kingpin fixing means.

Said kingpin fixing means can comprise a throughgoing bore, which is oriented transversely with respect to the axis of the taper roller bearings. The bore may have stepped portions of different diameter, the stepped portion with the larger diameter being positioned above the other stepped portion(s) to fit in a complete self contained, preloaded, lubricated and sealed for life kingpin unit. Alternatively, the kingpin may also have separate preloaded bearings e.g. taper bearings.

At the top and the bottom of the bore taper roller bearings in back-to-back or “O” configuration arrangement may be provided, as well as a kingpin, which is supported with respect to the fixing element by means of said bearings. Said kingpin can be provided with integrated inner rings, and the outer ring means has stepped diameter portions corresponding to the stepped diameter bore of the fixing member, or alternatively to fit separate bearings e.g. taper roller bearings. The kingpin has connection means at is top end and bottom end for connecting the fork end of a truck suspension thereto. Such kingpin with bearings and fixing means may be self contained, preloaded, lubricated and sealed for life.

In a preferred embodiment, the fixed member comprises a comer housing having a bore within which the rolling element bearings are accommodated, e.g. taper roller bearings or angular contact ball bearings or a combination of these. The bearings can therefore be preassembled within the comer housing, which means i.e. that the required preload or play within the bearings can be carried out by the bearing manufacturer under optimal conditions, such as in a clean environment and with the help of dedicated equipment. Moreover the bearings are well protected within the comer housing. The bearing unit is self contained, preloaded (or provided with play) and sealed for life.

The inner ring means may comprise a common inner ring provided with two raceways. Said common inner ring may extend beyond the comer housing and carries a hub provided with a mounting flange for mounting a wheel thereto. At its end which protrudes out of the comer housing, the common inner ring may have a radially outwardly protruding mounting flange onto which the hub is connected, e.g. by means of bolts which are screwed in screw threaded bores in said mounting flange.

The specific layout of the truck or trailer hub bearing unit according to the invention has the further advantage that the hub can be provided with a sleeve part which overlaps and at least partly surrounds the comer housing, a gap being present in the overlap area. Onto this sleeve part, the brake disc may be mounted. Thereby on the one hand a compact layout is obtained with limited radial dimension, and on the other hand a gap is available between the sleeve and the comer housing, which gap forms a heat barrier. Thus, the heat generated in the brake disc as a result of braking action cannot easily reach the bearings. To this end, also heat transfer may be obtained by means of cooling ribs on the comer housing, or fan ribs in the bore of the rotating sleeve.

Additionally, the common inner ring may have a bore which is provided with fixing means, e.g. an internal screw thread, and the comer housing may have an abutment, said fixing means and abutment being intended for engagement with a dismounting tool for dismounting the taper roller bearings. By screwing a dismounting screw in said internal screw thread, and abutting the end thereof to the abutment, the bearings can be forced out of the bore in the comer housing by applying a sustained screw action. A similar process can be applied for mounting the bearings into the bore of the comer housing, in case the comer housing is provided with a screw threaded bore which is aligned with the bore, and the inner ring means has an abutment, said screw threaded bore and abutment being intended for engagement with a mounting tool for mounting the taper roller bearings. In order to allow for mounting at service conditions the bolts in the flanged inner ring are in contact with the outer ringsection in pre-stressed condition. Doing so the inner ring and outer ring behave as “one piece” during pressing in which has then a negligible influence on the bearing pre-load.

The invention will now be described further with reference to the figures.

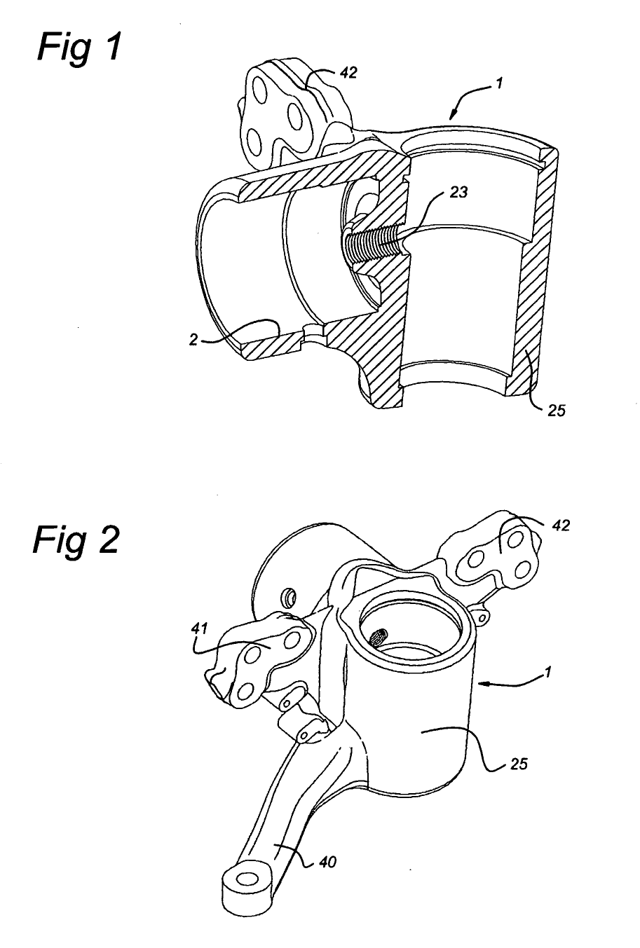

FIG. 1 shows a knuckle for the truck corner module according to the invention in cross section and perspective.

FIG. 2 shows the knuckle in perspective.

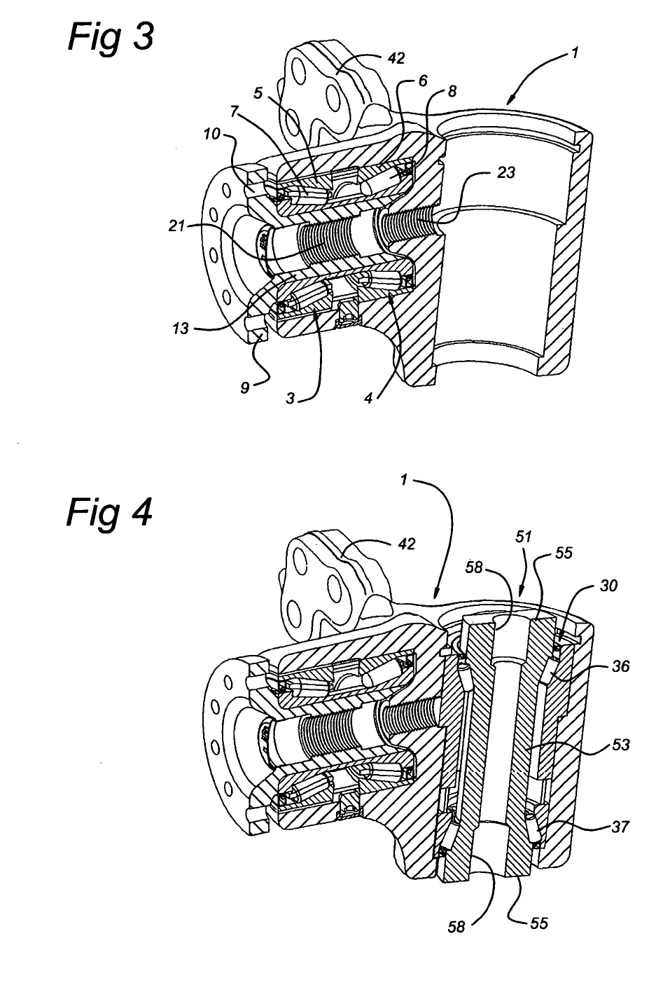

FIG. 3 shows the knuckle in the view of FIG. 1, together with a bearing arrangement.

FIG. 4 shows the truck comer module according to the invention in cross section and in perspective.

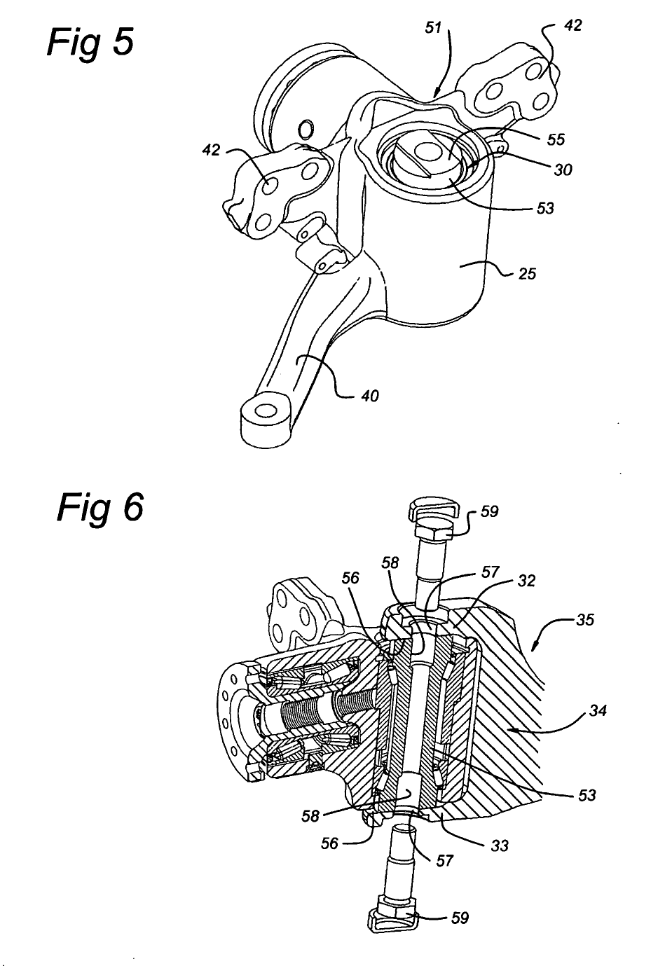

FIG. 5 shows the truck comer module in perspective.

FIG. 6 shows the step of assembling the truck corner module according to FIGS. 4 and 5 with the vehicle suspension.

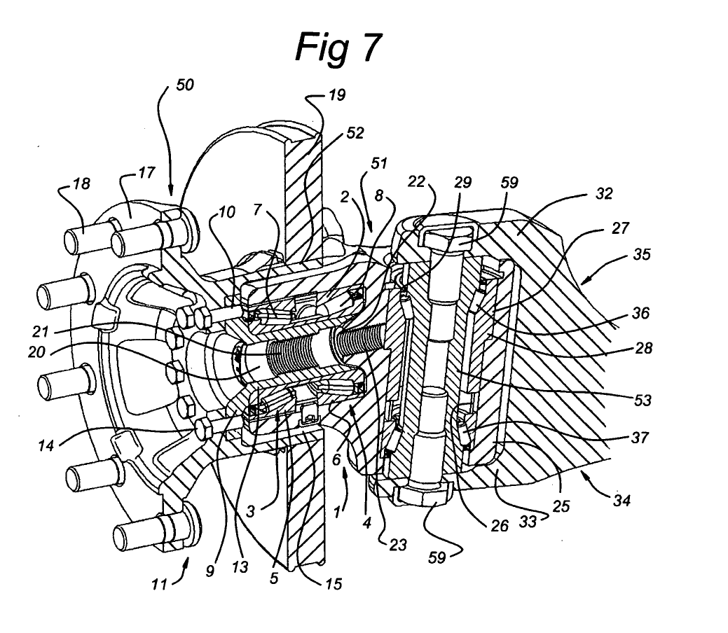

FIG. 7 shows the complete assembly in cross section and in perspective.

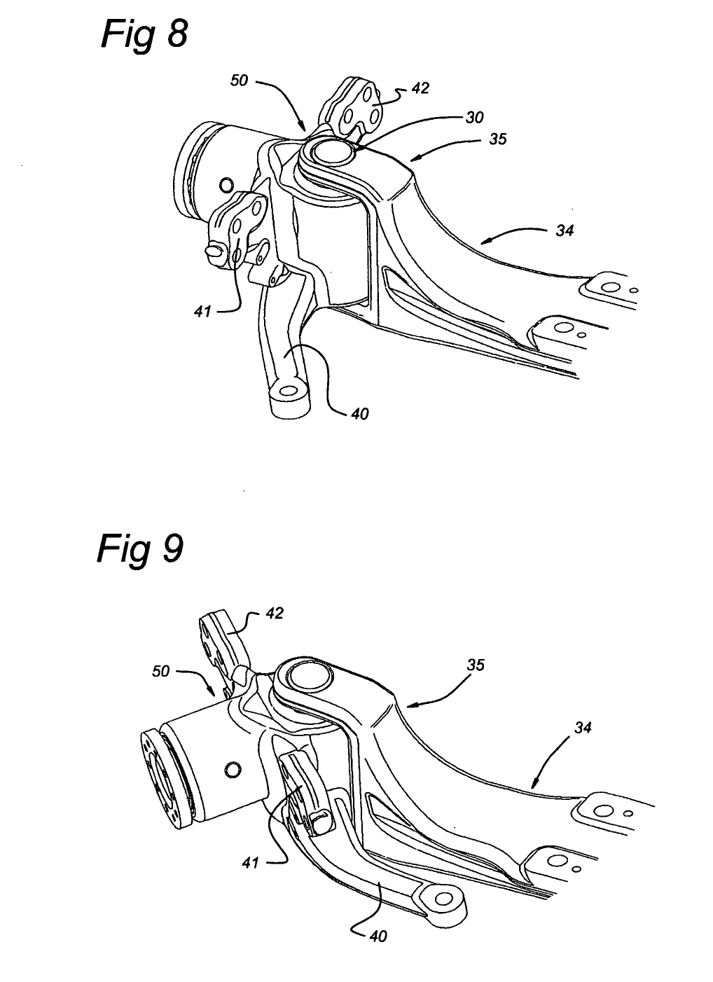

FIGS. 8, 9 and 10 show further views of the complete assembly.

FIG. 11 shows a further embodiment.

The assembly according to FIG. 7 consists of a hub bearing unit 50 and a vehicle suspension 35. This truck hub bearing unit 50 in turn consists of a truck comer module 51 having a comer housing or knuckle 1, which is provided with a bore 2, in which two taper roller bearings 3, 4 are accommodated. These taper roller bearings 3, 4 are arranged in an “O” configuration.

The taper roller bearings 3, 4 have a common inner ring 13, and two separate outer rings 5, 6. Two sets of taper rollers 7, respectively 8 are in contact with the raceways of the inner ring 13 and the outer rings 3, respectively 4.

The inner ring means 13 has a radially outwardly protruding flange 9, which has regularly spaced screw threaded holes 10. Onto the flange 9, a hub 11 is mounted by means of screws 14, which are screwed into the screw threaded holes 10. The hub 11 has a sleeve 12, which overlaps the comer housing 1, while leaving free a gap 15.

The hub has a radially outwardly extending flange 17, which carries screw threaded studs 18 onto which a wheel with wheel nuts (not shown) can be mounted. Furthermore, a brake disc 19 is mounted onto the disc mounting part 52 of the sleeve 12.

The common inner ring 9 has a bore 20 provided with an internal screw thread 21 and the comer housing has an abutment 22. By screwing a screw into the screw threaded part 21 and abutting this screw onto the abutment 22, the inner ring 9 together with the complete bearings 3, 4 can be dismounted.

Furthermore, the comer housing itself also has a screw threaded bore 23. By means of a screw (not shown) which is screwed in the screw threaded bore 23, and which bears for instance against the outer end of the flange 9, the bearings 3, 4 can be mounted into the comer housing 1.

Furthermore, the corner housing 1 is provided with a king pin fixing means 25, which has a through going bore with stepped portions 26, 27. Into this stepped bore, the outer ring 28 of a similar stepped shape is fitted by means of a spring clip 29. This outer ring 28 forms part of the kingpin means 30, which by means of bolts 31 is connected to the teeth 32, 33 of a fork 34, which is integrated with the vehicle suspension 35.

The outer ring means 28 forms part of the two taper roller bearings 36, 37, the raceways of which are integrated in respectively the outer ring means 28 and the kingpin 53 itself. The outer diameter of the outer rings differs in order to ease/reduce the stroke length for the mounting and dismounting.

FIGS. 1 and 2 show the comer housing or knuckle 1 in isolation. This comer housing 1 is integrated with a lever arm 40 for engagement with a steering rod of the vehicle's steering system (not shown), as well as ears 41, 42, for mounting a brake calliper which can engage the brake disc 19. Furthermore, an encoder sensor for ABS/wheel bearing speed may be integrated in the corner housing 1.

The corner bearing housing can also be equipped with a sensor (internal or external) to measure/control the wheel load.

FIG. 3 shows the corner housing according to FIGS. 1 and 2 together with the wheel taper roller bearing 3, 4 in back to back arrangement or “O” configuration.

FIG. 4 shows the complete truck corner module 51, comprising a corner housing 1 and the kingpin means 30.

FIG. 5 shows the complete truck corner module 51 in perspective.

The kingpin 53 has flat end faces 55, which, as shown in FIG. 6, come to bear against the facing surfaces 56 of the teeth 32, 33 of the fork 35 of the vehicle suspension 34. The teeth 32, 33 have holes 57, and the opposite ends of the kingpin 53 have screwthreaded bores 58. By means of bolts 59 the teeth 32, 33 are clamped firmly onto the surfaces 55 of the kingpin 53.

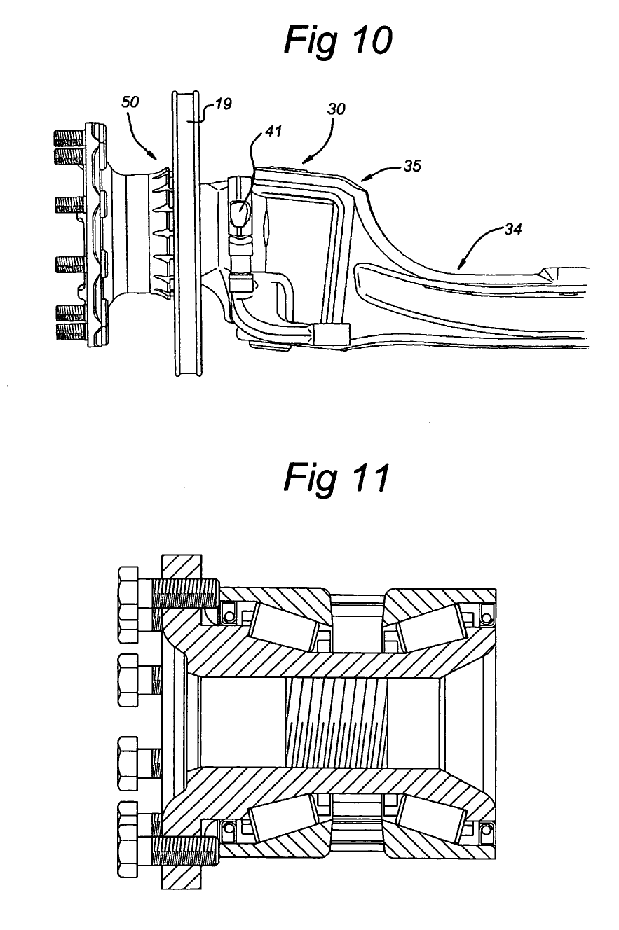

The front view of FIG. 10 shows the complete truck hub bearing unit including a brake disc brake 19 and suspension 34.

The unit can be shrink fitted or pressed into the housing; also, the unit can be pressed into the housing with pre-stressed bolts between the flange of the inner ring and outer ring (5) (see FIG. 11).

1. Truck hub bearing unit, comprising two rolling element bearings (3, 4), which comprise an inner ring means (13) and an outer ring means (5, 6) provided with raceways which are in rolling contact with two series of rolling elements (7, 18), a fixed member (1) for connection to the wheel suspension of the truck and a rotatable member (9) for supporting a wheel, said rotatatable member (9) being supported with respect to the fixed member (1) by means of said rolling bearings (3, 4), the outer ring means (7, 8) being connected to the fixed member (1) and the inner ring means (13) being connected to the rotatable member, characterized in that the fixed element (1) is provided with kingpin fixing means (25-27).

2. Unit according to claim 1, wherein the kingpin fixing means comprise a throughgoing bore (26, 27) which is oriented transversely with respect to the axis of the hub bearing unit (3, 4).

3. Unit according to claim 2, wherein the bore has stepped portions (26, 27) of different diameter, the stepped portion (2, 7) with the larger diameter being positioned above the other stepped portion(s) (26).

4. Unit according to claim 3, wherein at the top and the bottom of the bore (26, 27) taper roller bearings (36, 37) in “O” configuration have been provided (angular contact roller or ball bearing or a combination thereof), as well as a kingpin (51) which is supported with respect to the fixing element by means of said bearings (36, 37).

5. Unit according to claim 4, wherein the kingpin (51) is provided with integrated inner rings, and the outer ring means (28) has stepped diameter portions corresponding to the stepped diameter bore (26, 27) of the fixing member (25).

6. Unit according to claims 4 or 5, wherein the kingpin (51) has connection means (31) at is top end and bottom end for connecting the fork end (32-34) of a truck suspension thereto.

7. Unit according to any of the preceding claims, wherein the fixed member comprises a comer housing (1) having a bore (2) within which the rolling element bearings (3, 4) are accommodated.

8. Unit according to claim 7, wherein the outer ring means (7, 8) is fitted with respect to the inner wall of the bore (2).

9. Unit according to any of the preceding claims, wherein the inner ring means comprises a common inner ring (13) provided with two raceways.

10. Unit according to claim 9, wherein the common inner ring (13) extends beyond the comer housing (1) and carries a hub (11) provided with a mounting flange (17) for mounting a wheel thereto.

11. Unit according to claim 10, wherein the common inner ring (13) at its end extending beyond the comer housing has a radially outwardly protruding mounting flange (9) onto which the hub (11) is connected.

12. Unit according to claim 10 or 11, wherein the hub (11) is provided with a sleeve part (12) which overlaps and at least partly surrounds the comer housing (1), a gap (15) being present in the overlap area.

13. Unit according to claim 12, wherein the sleeve part (12) is provided with means (50) for connecting a brake disk or brake drum thereto.

14. Unit according to any of claims 9-13, wherein the common inner ring (13) or common central shaft has a bore (20) which is provided with fixing means, e.g. an internal screw thread (21), and the comer housing (1) has an abutment (22), said fixing means (23) and abutment (22) being intended for engagement with a dismounting tool for dismounting of the hub bearing unit.

15. Unit according to claims 14, wherein the comer knuckle (9) housing (1) is provided with a screw threaded bore (23) which is aligned with the inner ring means bore (20), and the inner ring means has an abutment, said screw threaded bore (23) and abutment being intended for engagement with a mounting tool for mounting the hub bearing unit.

16. Unit according to claim 7, wherein the comer housing consists of one piece of forged iron, cast iron, or of a non-metallic material.

17. Unit according to claim 12, wherein the comer housing (1) has cooling ribs, which extend in the gap (15) in the overlap area.

18. Unit according to any of the preceding claims, wherein an integrated sensor is provided for monitoring/controlling the number of wheel rotations, temperature, etc.

19. Unit according to any of the preceding claims, wherein the housing/knuckle is made of a metallic, non-metallic or composite material.

20. Unit according to any of the preceding claims wherein the housing is made of a forging or cast iron.

21. Unit according to any of the preceding claims, wherein a brake disc or brake drum is provided.

22. Unit according to any of the preceding claims, wherein the inner ring means comprises separate inner rings mounted on a common shaft.
